(19) United States
(12) Patent Application Publication
(10) Pub. No.: US 2003/0108205 A1
(43) Pub. Date: Jun. 12, 2003

(54) System and method for providing encrypted data to a device

(76) Inventors: Bryan Joyner, Murphy, TX (US); Joe B. Vaughan JR., Flower Mound, TX (US); Justin Sadowski, Dallas, TX (US); Charles F. Shelor, Arlington, TX (US)

Correspondence Address: Daniel J. Chalker, GARDERE WYNNE SEWELL LLP, Suite 3000, 1601 Elm Street, Dallas, TX, 75201-4767, US

(21) Appl. No.: 10/010,004

(22) Filed: Dec. 7, 2001

(51) Int. Cl. H04L 9/00

(52) U.S. Cl. 380/277

(57) ABSTRACT

The present invention provides a system and method of providing encrypted data to a device. One or more public keys are received from the device and then validated. A request for the encrypted data is received from the device, and the encrypted data and a symmetric key used to encrypt the data is retrieved. The symmetric key is then encrypted using each of the one or more public keys, and the one or more encrypted symmetric keys and the encrypted data are sent to the device. This method can be implemented using a computer program with various code segments to implement the steps of the method. The system includes a processor, a data storage device communicably coupled to the processor and a communications interface communicably coupled to the processor. The processor executes the method as described above.

### TECHNICAL FIELD OF THE INVENTION

The present invention relates generally to the field of communications and, more particularly, to a system and method for providing encrypted data to a device.

### BACKGROUND OF THE INVENTION

Consumers want the ability to obtain high quality digital audio and video content from the Internet on demand. Content providers, such as movie studios, music companies, artists and movie/music rental companies, also want to provide such content to consumers, but only if they are compensated and their content can be protected from unauthorized use and duplication.

Encryption and coding techniques have been used to protect content in digital video discs (“DVDs”) and other media. But those systems typically maintain the security of the content by keeping the decrypted digital content within the hardware and allowing the user to only have access to an analog output or acceptable digital output. Content security is at risk from hackers and unauthorized use when the encryption/decryption processing is performed via software within a computer. As a result, content providers have been slow to embrace the Internet as an on-demand distribution medium. Moreover, traditional methods of content encryption/decryption for transmission via the Internet have been to slow to provide customers with high quality reception that is competitive to DVD rental, digital cable or satellite television. This is largely due to the time required to encrypt the content on the server, transmit the encrypted content from the server to the client, decrypt the content on the client and “play” the content. Accordingly, there is a need for a system and method for providing encrypted data to a device that meets the demands of both the customer and the content provider.

### SUMMARY OF THE INVENTION

The present invention provides a system and method for providing encrypted data to a device that meets the demands of both the customer and the content provider. More specifically, the present invention improves delivery of encrypted data via a network by encrypting the data with a symmetric key before it is requested and then storing the encrypted data and the symmetric key for later retrieval and transmission.

The present invention provides a method of providing encrypted data to a device. One or more public keys are received from the device and then validated. A request for the encrypted data is received from the device, and the encrypted data and a symmetric key used to encrypt the data is retrieved. The symmetric key is then encrypted using each of the one or more public keys, and the one or more encrypted symmetric keys and the encrypted data are sent to the device. This method can be implemented using a computer program with various code segments to implement the steps of the method.

The present invention also provides a system for providing encrypted data to a device. The system includes a processor, a data storage device communicably coupled to the processor and a communications interface communicably coupled to the processor. The processor receives one or more public keys from the device via the communications interface and validates the one or more public keys. The processor also receives a request for the encrypted data from the device via the communications interface, and retrieves the encrypted data and a symmetric key used to encrypt the data from the data storage device. Next, the processor encrypts the symmetric key using each of the one or more public keys, and sends the one or more encrypted symmetric keys and the encrypted data to the device via the communications interface.

Other features and advantages of the present invention shall be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a block diagram of a content delivery system in accordance with one embodiment of the present invention;

FIG. 2 is a block diagram of an encrypted content provider (server) in accordance with one embodiment of the present invention;

FIG. 3 is a block diagram of a device (client) in accordance with one embodiment of the present invention;

FIG. 4A is a block diagram of a decryption path of a device (client) in accordance with one embodiment of the present invention;

FIG. 4B is a block diagram of an encryption path of a device (client) in accordance with one embodiment of the present invention;

FIG. 5 is a flowchart of a content delivery system in accordance with one embodiment of the present invention;

FIGS. 6A, 6B and 6C are various file formats to deliver content in accordance with one embodiment of the present invention;

FIG. 7 is a block diagram of a peer-to-peer content delivery system in accordance with one embodiment of the present invention;

FIG. 8 is another block diagram of a peer-to-peer content delivery system in accordance with one embodiment of the present invention;

FIGS. 9A and 9B are flowcharts of a peer-to-peer content delivery system in accordance with one embodiment of the present invention;

FIG. 10A is a block diagram of a decryption path and decoding path of a peer device in accordance with one embodiment of the present invention;

FIG. 10B is a block diagram of an encryption and encoding path of a peer device in accordance with one embodiment of the present invention;

FIG. 11A is a block diagram of a decryption path and decoding path of a peer device in accordance with another embodiment of the present invention; and

FIG. 11B is a block diagram of an encryption path of a peer device in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. For example, in addition to telecommunications systems, the present invention may be applicable to other forms of communications or general data processing. Other forms of communications may include communications between networks, communications via satellite, or any form of communications not yet known to man as of the date of the present invention. The specific embodiments discussed herein are merely illustrative of specific ways to make and use the invention and do not limit the scope of the invention.

The present invention provides a system and method for providing encrypted data to a device that meets the demands of both the customer and the content provider. More specifically, the present invention improves delivery of encrypted data via a network by encrypting the data with a symmetric key before it is requested and then storing the encrypted data and the symmetric key for later retrieval and transmission.

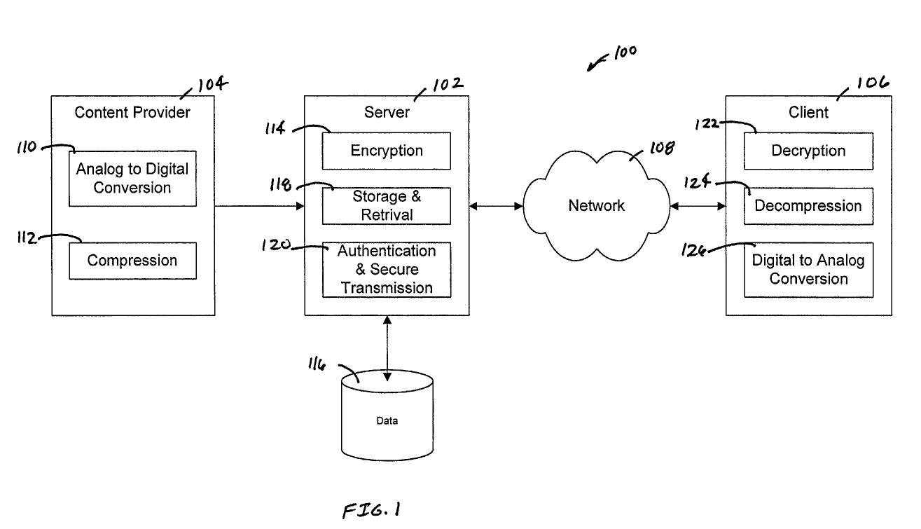

Referring to FIG. 1, a block diagram of a content delivery system 100 in accordance with one embodiment of the present invention is shown. The client delivery system 100 primarily includes one or more servers 102 that receive data or content from a content provider 104. The one or more servers 102 then deliver the data or content in an encrypted format to a client 106 that requests the data or content via network 108. The data or content can be concerts, broadcasts, games, multimedia, music, movies, television programs, audio/video transmissions (real time conferencing or recordings), and sound recordings.

The content providers 104 can be movie studios, music companies, artists, movie/music rental companies or anyone that wants to make audio and/or video content available to customer using a secure environment. The content provider 104 can specify the terms and conditions, and the level of security by which customers (client 106) can access the data or content via the content distributor or service provider (server 102). Typically, the content provider 104 will convert the content from an analog to a digital format (process 110), if necessary, and compress the content (process 112). The content provider 104 then provides the content to the server 102 in a compressed digital format. Some of the more commonly used digital compression standards are produced by the Moving Picture Experts Group (“MPEG”), such as MPEG-1 (VCD and MP3 products), MPEG-2 (digital television set top boxes and digital video discs (“DVD”), MPEG-4 (multimedia for the web and mobility), MPEG-7 (multimedia content description interface) and MPEG-21 (multimedia framework). The present invention is not restricted to these formats, and can, therefore, accept, store and distribute content provided in any format.

The server 102 can, however, receive the content in an analog and/or uncompressed format and, if necessary, convert the content from analog to digital format or compress the content as required. The server 102 encrypts the content (process 114) and stores the encrypted content along with the encryption key in a data storage device 116 (process 118). The present invention can use any desired standard or proprietary encryption process 114, such as a triple Data Encryption Standard (“3DES”) algorithm, an Advanced Encryption Standard (“AES”) algorithm, or a linear feedback shift register (“LFSR”) sequence. The server 102 may encrypt and store several versions of the same content. For example, the same movie could be made available in MPEG-2 and MPEG-4 formats. Moreover, each of these formats could be made available in more than one encrypted format, such as 3DES and AES. The server 102 also authenticates the client 106 and provides the secure transmission link to the client 106 via network 108 (process 120). Once a client is properly authenticated, the server 102 retrieves the requested content from the data storage device 116 for delivery to the client 106 (process 118). The data storage device 116 can be a single device or numerous devices communicably coupled via a network. Moreover, the data storage device 116 can be located within or physically near the server 102 (local), physically remote to the server 102, or any combination thereof.

The server 102 can be communicably coupled to the client 106 using any direct or network communication link. The Internet is a good example of network 108. But, network 108 can be a telephone line, a wireless network, a satellite network or any combination thereof. Likewise, the client 106 can be any type of audio and/or video playback device, such as a computer, game console, personal data assistant, MP3 player, DVD player, CD player, television, television set top box or wireless network device. The client 106 decrypts the content (process 122), decompresses the content (process 124) and may convert the content from a digital format to an analog format (process 126).

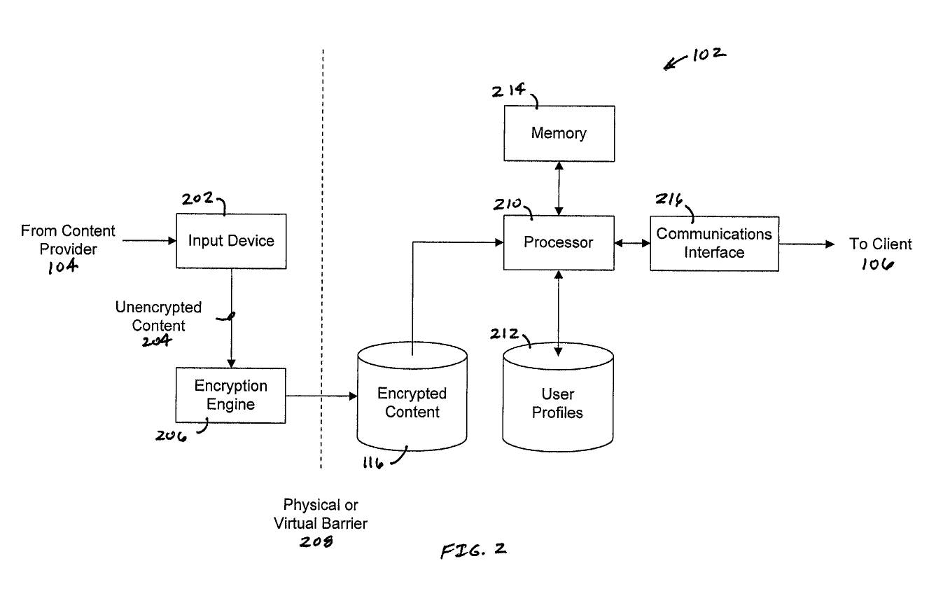

Now referring to FIG. 2, a block diagram of an encrypted content provider (server 102) in accordance with one embodiment of the present invention is shown. The server 102 receives content from the content provider 104 via an input device 202, which can be a communication link, a disk drive, optical disk reader, magnetic tape reader or any other means of reading or receiving data. The decrypted content 204 is encrypted using an encryption engine 206, which can be hardware, software or a combination of both. The encryption engine 206 can use any desired standard or proprietary encryption process, such as a 3DES algorithm, an AES algorithm or a LFSR sequence. The decrypted content 204 can also be stored in a data storage device (not shown) for later encryption. As previously described, the server 102 can also convert the content from an analog to digital format and/or compress the content before it is encrypted using the encryption engine 206. The encryption engine 206 stores the encrypted content along with the encryption key in a database or data storage device 116. The encryption engine 206 may encrypt and store several versions of the same content (compression formats and encryption formats). The data storage device 116 and the encryption engine 206 are physically or virtually isolated from one another via barrier 208 to prevent any unauthorized access to the decrypted content 204.

The delivery portion of the server 102 includes a processor 210 communicably coupled to the data storage device 116, a user profile database 212, a memory 214 and a communications interface 216. The processor 210 uses the user profile database 212 to authenticate and validate the clients 106. The user profile database 212 can also be used for maintaining and storing customer profiles, purchases or rentals, billing, quality of service options, client hardware and software configurations, and client download terms and restrictions. The memory 214 can be read only memory (“ROM”), random access memory (“RAM”) or any other type of memory required by the processor 210 to implement content delivery system. The communications interface 216 can be any number of different interfaces that allow the server 102 and the client 106 to communicate.

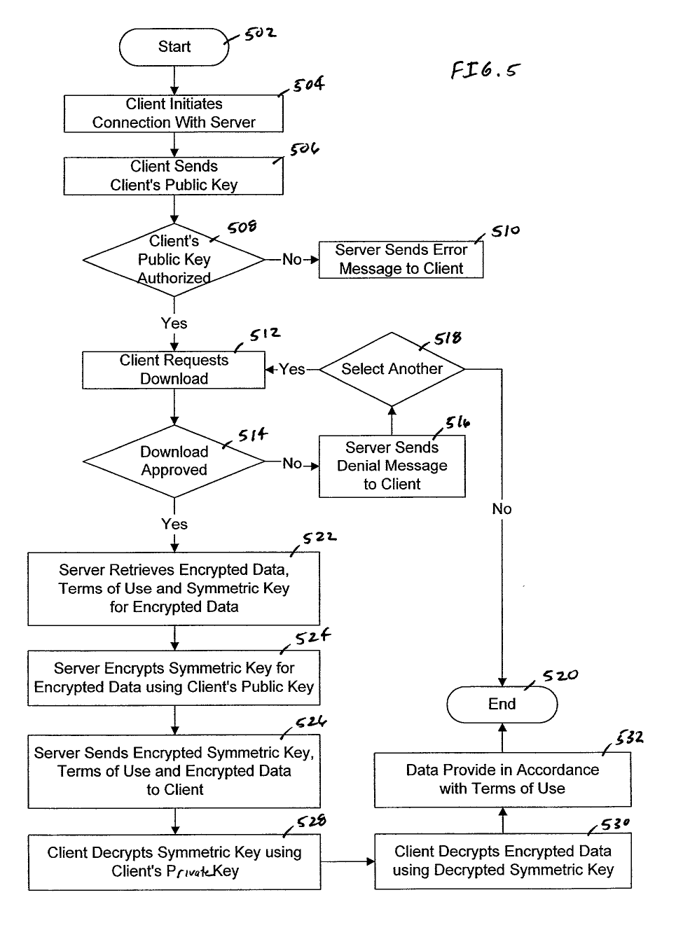

As will be described in more detail in reference to FIG. 5, the processor 210 receives one or more public keys from the client device 106 via the communications interface 216 and validates the one or more public keys using the user profile database 212. The one or more public keys are each contained within a certificate signed by the manufacturer or provider of the client device 106. Each certificate is validated by verifying its signature using the manufacturer or provider's certificate. The processor 210 also receives a request for the encrypted data from the client device 106 via the communications interface 216, and retrieves the encrypted data and a symmetric key used to encrypt the data from the data storage device 116. Next, the processor 210 encrypts the symmetric key using each of the one or more public keys, and sends the one or more encrypted symmetric keys and the encrypted data to the client device 106 via the communications interface 216.

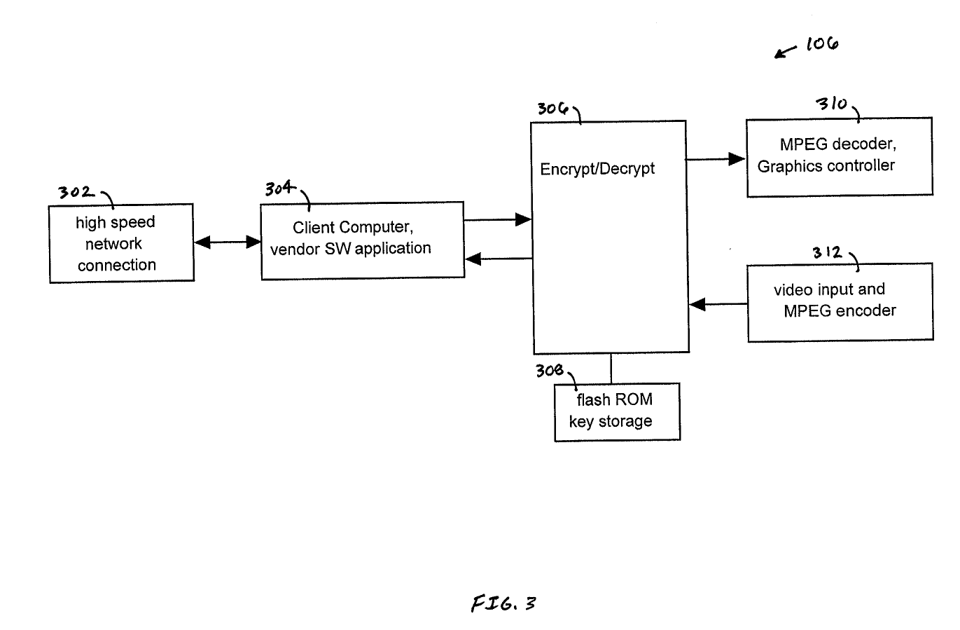

Now referring to FIG. 3, a block diagram of a device (client 106) in accordance with one embodiment of the present invention is shown. As shown, only those elements of the client device 106 that handle the content are shown. The other elements of the client device 106 will vary depending on the specific client device 106 being used. The client device 106 receives and transmits data via a high-speed network connection 302. The actual speed of the network connection 302 will vary according to the client device 106 and the content being received or transmitted. Network connection 302 can be a direct or network connection via a telephone line, a wireless network, a satellite network or any combination thereof The network connection 302 is communicably coupled to a software application 304 that controls the encrypted content flow between the network connection 302 and the encryption/decryption device 306. The encryption/decryption device 306 is communicably coupled to a flash ROM key storage 308, a decoder/graphics controller 310 and an input/encoder 312. When the encryption/decryption device 306 receives encrypted content from the software application 304, it decrypts the content and sends the decrypted content to the decoder/graphics controller 308, which decompresses the decrypted content, if required, and performs a digital to analog conversion so that the decrypted and decompressed content can be displayed. Likewise, the input/encoder 312 receives analog or digital content, converts the content to a digital format (if required), compresses the content (if required) and delivers the content to the encryption/decryption device 306 for encryption and subsequent delivery to the software application 304.

The encryption/decryption device 306 can be implemented as a single chip or as all or part of a card. Moreover, some applications may only require that the encryption/decryption device 306 perform one function, either encryption or decryption. The flash ROM key storage 308 can be part of the encryption/decryption device 306. The key storage 308 is used to store a unique private key that has been given to each client device 106. At the time of purchase, the customer is given a certificate for the device 106 that contains the corresponding public key. When the customer chooses to purchase some content, he presents this certificate to the server 102 (content distributor) (FIG. 1). The server 102 (FIG. 1) verifies that the certificate corresponds to a valid player (device 106) and then encrypts the content using the device's public key and transmits the encrypted content to the device 106. The certificate may be instead encoded on a removable smart card so that the content can “travel” with the owner of the smart card rather than the device itself.

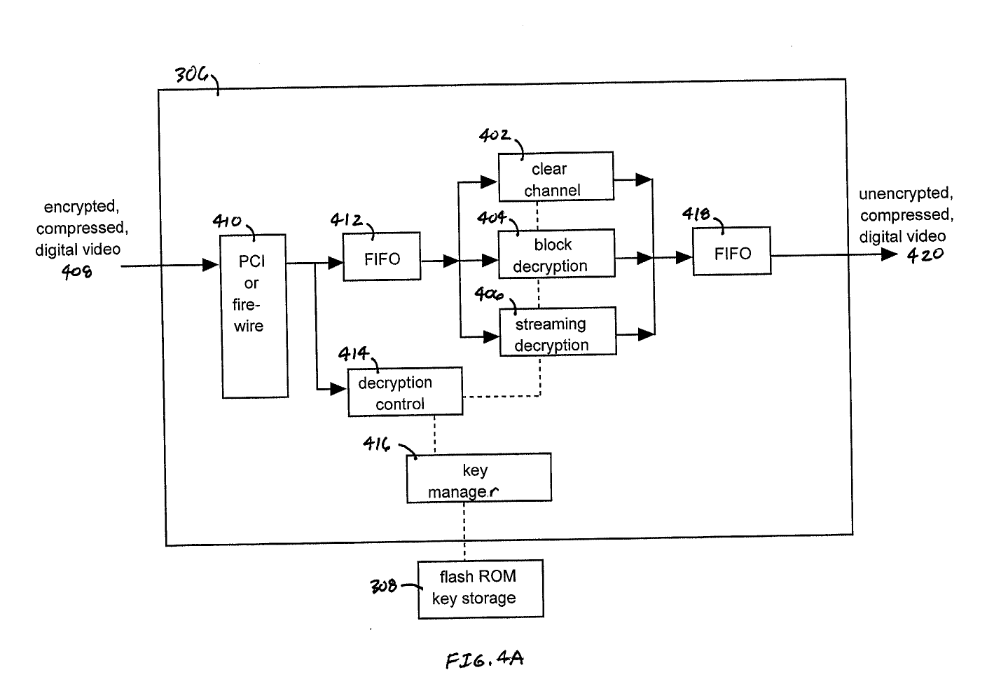

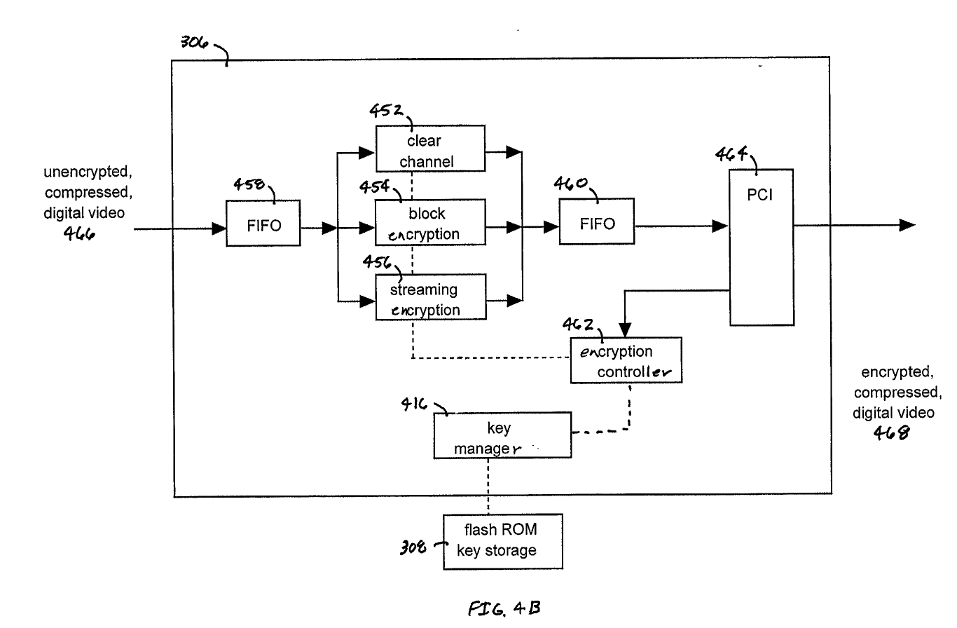

Referring now to FIG. 4A, a block diagram of a decryption path of a device (client 106) in accordance with one embodiment of the present invention. The encryption/decryption device 306 shown in FIG. 4A is a multimode device because it can process unencrypted content (clear channel path 402), content encrypted using a first decryption algorithm (block decryption path 404) and a second decryption algorithm (streaming decryption path 406). Note that a multimode encryption/decryption device 306 is not required by the present invention. Also note that the present invention is not limited to a single algorithm for streaming encryption/decryption and a single algorithm for block encryption/decryption as both 3DES and AES algorithms could be implemented within a single embodiment of the present invention for block encryption/decryption. Nor is the present invention limited to a total of two encryption/decryption algorithms. For example, the present invention is capable of providing two or more types of block encryption/decryption and two or more types of streaming encryption/decryption within a single embodiment. The encryption/decryption device 306 includes a PCI interface 410 communicably coupled to a first buffer 412 (first in, first out) and a decryption controller 414. Note that the PCI interface 410 can be any standard or high-speed digital interface, such as FireWire, USB-2, Fast Ethernet or AGP interfaces. The first buffer 412 is communicably coupled to the clear channel path 402, the block decryption path 404 (first decryption algorithm) and the streaming decryption path 406 (second decryption algorithm). The clear channel path 402, the block decryption path 404 (first decryption algorithm) and the streaming decryption path 406 (second decryption algorithm) are communicably coupled to a second buffer 418 (first in, first out). The decryption controller 414 is communicably coupled to the clear channel path 402, the block decryption path 404 (first decryption algorithm), the streaming decryption path 406 (second decryption algorithm) and a key manager 416. The key manager 416 is communicably coupled to the key storage 108. The security keys are embedded within the hardware of the client device 106 so that they cannot be compromised by sharing data, such as electronic mail, newsgroup posts, file transfers, etc.

As shown, the encryption/decryption device 306 receives encrypted, compressed digital content (audio/video) 408 via the PCI interface 410 and places the encrypted, compressed digital content (audio/video) 408 in the first buffer 412. The decryption controller 414 checks the encrypted compressed digital content (audio/video) 408 and determines which path 402, 404 or 406 will process the content 408. The decryption controller 414 also monitors and controls the clear channel path 402, the block decryption path 404 (first decryption algorithm) and the streaming decryption path 406 (second decryption algorithm). The clear channel path 402 receives content from the first buffer 412 and may perform some processing on the content before it is placed in the second buffer 418 for output as unencrypted, compressed digital content (audio/video) 420.

The block decryption path 404 (first decryption algorithm) receives content from the first buffer 412 and decrypts the content using a first decryption algorithm before it is placed in the second buffer 418 for output as unencrypted, compressed digital content (audio/video) 420. The block decryption path 404 (first decryption algorithm) uses a low to medium speed, high security, standard or proprietary encryption process, such as a 3DES algorithm or an AES algorithm. The block decryption path 404 is typically used to decrypt content that is in a file format or other type of data block in a batch or off-line process. The decryption controller 414 requests the appropriate security key from the key manager 416 and provides the security key to the block decryption path 404 for use in decrypting the content.

The streaming decryption path 406 (second decryption algorithm) receives content from the first buffer 412 and decrypts the content using a second decryption algorithm before it is placed in the second buffer 418 for output as unencrypted, compressed digital content (audio/video) 420. The streaming decryption path 406 (second decryption algorithm) uses a high speed, medium security, standard or proprietary encryption process, such as a LFSR sequence. The streaming decryption path 406 is typically used to decrypt content during a real time or near real time on line process. This provides low latency delays for interactive applications, such as gaming and video conferencing. This also reduces hardware complexity to allow the present invention to be easily integrated into portable client devices. The decryption controller 414 requests the appropriate security key from the key manager 416 and provides the security key to the streaming decryption path 406 for use in decrypting the content.

Now referring to FIG. 4B, a block diagram of an encryption path of a device (client 106) in accordance with one embodiment of the present invention is shown. As previously described, the encryption/decryption device 306 shown in FIG. 4B is a multimode device because it can process unencrypted content (clear channel path 452), content encrypted using a first encryption algorithm (block encryption path 454) and a second encryption algorithm (streaming encryption path 456). The encryption/decryption device 306 includes a first buffer 458 communicably coupled to the clear channel path 452, the block encryption path 454 (first encryption algorithm) and the streaming encryption path 456 (second encryption algorithm). The clear channel path 452, the block encryption path 454 (first encryption algorithm) and the streaming encryption path 456 (second encryption algorithm) are communicably coupled to a second buffer 460 (first in, first out) and an encryption controller 462. The second buffer 460 is communicably coupled to a PCI interface 464. The PCI interface 464 is also communicably coupled to the encryption controller 462. Note that the PCI interface 464 can be any standard or high-speed digital interface, such as FireWire, USB-2, Fast Ethernet or AGP interfaces. The encryption controller 462 is communicably coupled to the clear channel path 452, the block encryption path 454 (first encryption algorithm), the streaming encryption path 456 (second encryption algorithm) and the key manager 416, which was previously described in reference to FIG. 4A.

As shown, the encryption/decryption device 306 receives unencrypted, compressed digital content (audio/video) 466 via first buffer 458. The encryption controller 462 determines which path 452, 454 or 456 will process the content 466. The encryption controller 462 also monitors and controls the clear channel path 452, the block encryption path 454 (first encryption algorithm) and the streaming encryption path 456 (second encryption algorithm). Once processed and placed in the second buffer 460, the encrypted, compressed digital content (audio/video) 468 is sent out via the PCI interface 464. The clear channel path 452 receives content from the first buffer 458 and may perform some processing on the content before it is placed in the second buffer 460.

The block encryption path 454 (first encryption algorithm) receives content from the first buffer 458 and encrypts the content using a first encryption algorithm before it is placed in the second buffer 460. The block encryption path 454 (first encryption algorithm) uses a low to medium speed, high security, standard or proprietary encryption process, such as a 3DES algorithm or an AES algorithm. The block encryption path 454 is typically used to encrypt content that is in a file format or other type of data block in a batch or off-line process. The encryption controller 462 requests the appropriate security key from the key manager 416 and provides the security key to the block encryption path 454 for use in encrypting the content.

The streaming encryption path 456 (second encryption algorithm) receives content from the first buffer 458 and encrypts the content using a second encryption algorithm before it is placed in the second buffer 460. The streaming encryption path 456 (second encryption algorithm) uses a high speed, medium security, standard or proprietary encryption process, such as a LFSR sequence. The streaming encryption path 456 is typically used to encrypt content during a real time or near real time on line process. This provides low latency delays for interactive applications, such as gaming and video conferencing. This also reduces hardware complexity to allow the present invention to be easily integrated into portable client devices. The encryption controller 462 requests the appropriate security key from the key manager 416 and provides the security key to the streaming decryption path 456 for use in decrypting the content.

Referring now to FIGS. 1 and 5, FIG. 5 is a flowchart of a content delivery system in accordance with one embodiment of the present invention. The process starts in block 502. The client 106 initiates a communication link with the server 102 via network 108 in block 504. The client 106 then sends the client's public key to the server 102 in block 506. If the client's public key is not authorized as determined by the server 102 in decision block 508, the server 102 sends an error message to the client 106 in block 510. The client 106 can then retry the authorization process or attempt to remedy the error. If, however, the client's public key is authorized as determined by the server 102 in decision block 508, the client 106 then requests the content to be downloaded in block 512. The server 102 determines whether the download should be approved in decision block 514. The approval process may include a check of the client's account status, and device, connection and encryption compatibilities. If the download is not approved, as determined in decision block 514, the server 102 sends a denial message to the client 106 in block 516. If the client 106 decides not to retry or make another selection, as determined in decision block 518, the process ends in block 520. If, however, the client 106 decides to retry or make another selection, as determined in decision block 518, the process loops back to block 512 where the client 106 requests another download.

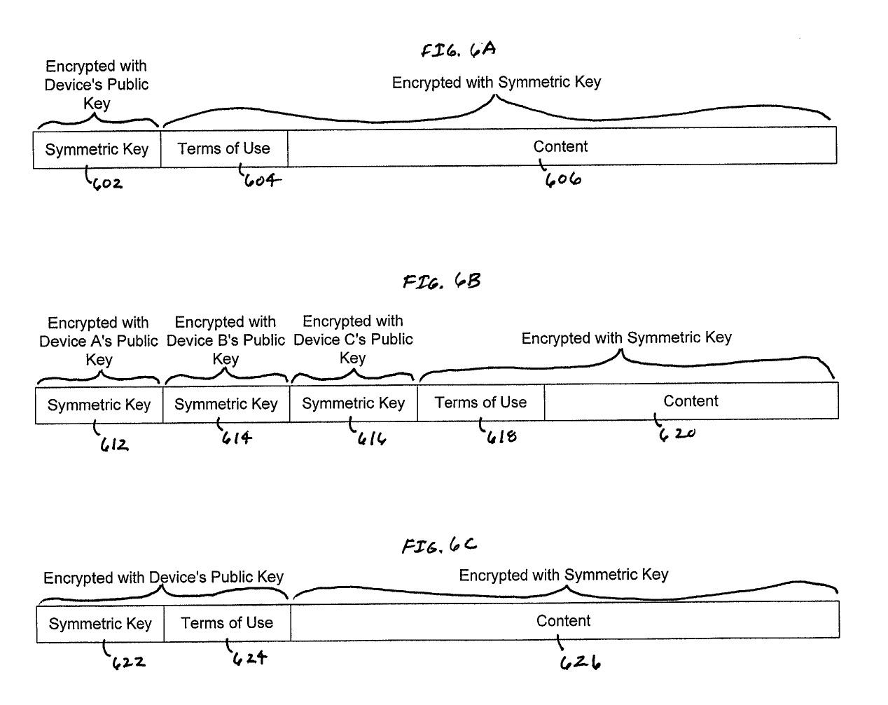

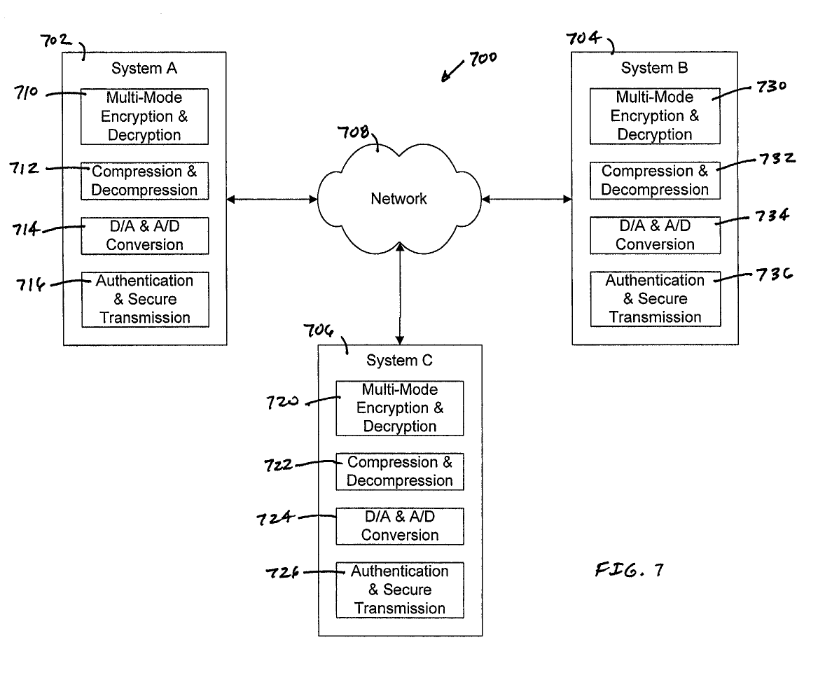

If, however, the download is approved, as determined in decision block 514, the server 102 retrieves the encrypted data, one or more terms of use and the symmetric key for the encrypted data from data storage device 116 in block 522. The terms of use allow the content provider 104 or the server 102 to specify restrictions on the playback of the content. For example, the terms of use may include a view only once restriction, a limited time period to view the content, a reproduction restriction or any other restriction that the content provider 104 or server 102 wishes associate with the content. The server 102 then encrypts the symmetric key for the encrypted data using the client's private key in block 524 and sends the encrypted symmetric key, terms of use and encrypted data to the client 106 in block 526. The encrypted symmetric key, terms of use and encrypted data can be sent as one file as will be described in reference to FIGS. 6A, 6B and 6C. After receiving the data, the client 106 decrypts the symmetric key using the client's private key in block 528 and decrypts the encrypted data using the decrypted symmetric key in block 530. The data is then provided to the user in accordance with the terms of use in block 532 and the process ends in block 520.

Now referring to FIGS. 6A, 6B and 6C, various file formats to deliver content in accordance with one embodiment of the present invention are shown. FIG. 6A depicts a file that is intended for delivery to a single client device. The file includes encrypted symmetric key 602, which has been encrypted using the client's public key, and encrypted terms of use for the content 604 and the encrypted content 606, both of which have been encrypted using the symmetric key. FIG. 6B depicts a file that is intended for delivery to a client device A with further distribution to client devices B and C. For example, a single customer has several playback devices and would like to be able to use his content in all of them, such as a video playback device in his or her living room, den and bedroom. Or, the customer wants to temporarily play the content on another customer's device, such as a video playback device at a friend's house. The file includes encrypted symmetric key 612, which has been encrypted using the client device A's public key, encrypted symmetric key 614, which has been encrypted using the client device B's public key, encrypted symmetric key 616, which has been encrypted using the client device C's public key, and encrypted terms of use for the content 618 and the encrypted content 620, both of which have been encrypted using the symmetric key. As a result, each device A, B and C decrypts the content using its own private key. FIG. 6C depicts a file that is intended for delivery to a single client device. The file includes encrypted symmetric key 622 and encrypted terms of use for the content 624, both of which have been encrypted using the client's public key, and the encrypted content 626, which has been encrypted using the symmetric key.

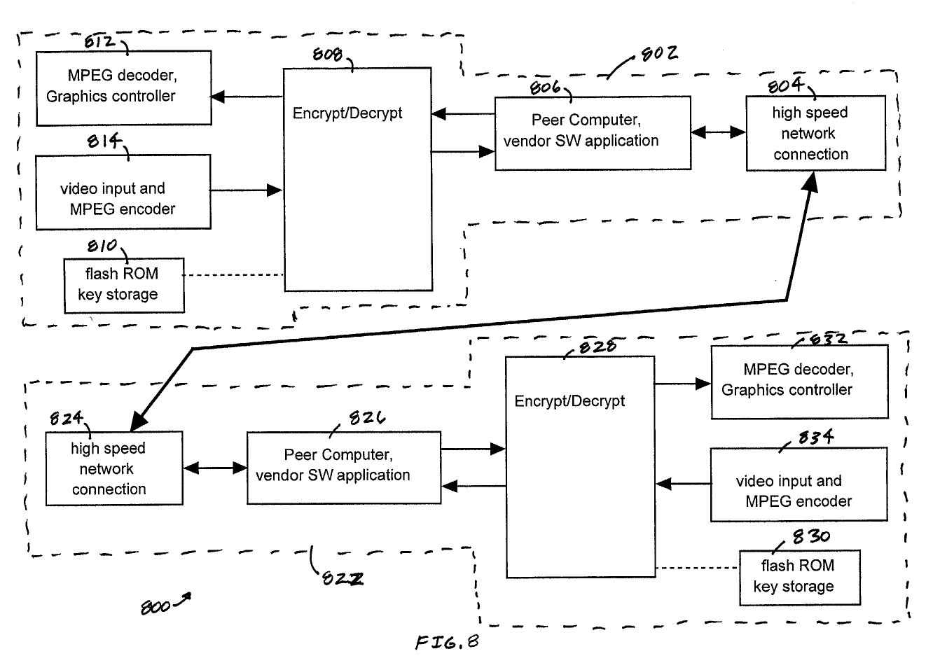

Referring now to FIG. 7, a block diagram of a peer-to-peer content delivery system 700 in accordance with one embodiment of the present invention is shown. The peer-to-peer content delivery system 100 primarily includes two or more systems, such as system A 702, system B 704 and system C 706, that transmit and receive encrypted data or content from one to another via network 708. Although the content can be of any type, the system is particularly well suited for video conferencing. Systems A 702, B 704 and C 706 can be communicably coupled to one another using any direct or network communication link. The Internet is a good example of network 708. But, network 708 can be a telephone line, a wireless network, a satellite network or any combination thereof.

System A 702 includes multi-mode encryption and decryption processes 710, compression and decompression processes 712, digital to analog and analog to digital conversion processes 714 and authentication and secure transmission processes 716. The multi-mode encryption and decryption processes 710 were previously described in reference to FIGS. 4A and 4B. Note that the encryption and decryption processes of System A 702 can be implemented as a single mode encryption and decryption process. The encryption and decryption processes of System A 702 can use any desired standard or proprietary encryption process, such as a 3DES algorithm, an AES algorithm, or a LFSR sequence. The LFSR is probably better suited for the video conferencing application. The compression and decompression processes 712 and the digital to analog and analog to digital conversion processes 714 can use any standard or proprietary technique known to those skilled in the art. The authentication and secure transmission processes 716 are used to setup, monitor and control the initiation and maintenance and tear down of the communication link between the systems 702, 704 and 706. Similarly, System B 704 includes multi-mode encryption and decryption processes 720, compression and decompression processes 722, digital to analog and analog to digital conversion processes 724 and authentication and secure transmission processes 726, and System C 706 includes multi-mode encryption and decryption processes 730, compression and decompression processes 732, digital to analog and analog to digital conversion processes 734 and authentication and secure transmission processes 736.

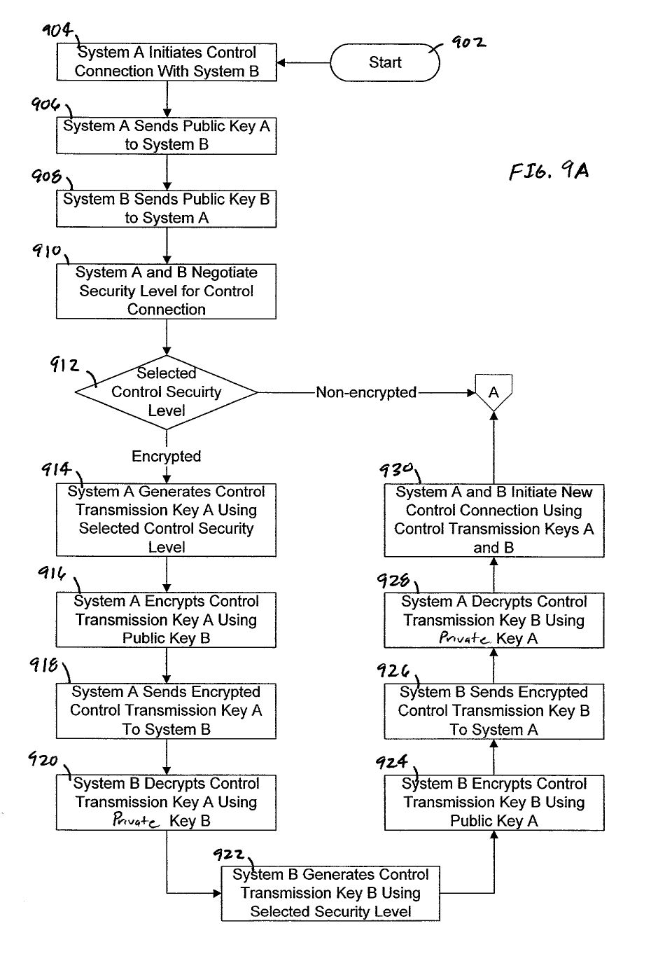

Now referring to FIG. 8, another block diagram of a peer-to-peer content delivery system 800 in accordance with one embodiment of the present invention is shown. Device 802 receives and transmits data via a high-speed network connection 804. The actual speed of the network connection 804 will vary according to the device 802 and the content being received or transmitted. Network connection 804 can be a direct or network connection via a telephone line, a wireless network, a satellite network or any combination thereof. The network connection 804 is communicably coupled to a software application 806 that controls the encrypted content flow between the network connection 804 and the encryption/decryption device 808. The encryption/decryption device 808 is communicably coupled to a flash ROM key storage 810, a decoder/graphics controller 812 and an input/encoder 814. When the encryption/decryption device 808 receives encrypted content from the software application 806, it decrypts the content and sends the decrypted content to the decoder/graphics controller 810, which decompresses the decrypted content and performs a digital to analog conversion so that the decrypted and decompressed content can be displayed. Likewise, the input/encoder 814 receives analog or digital content, converts the content to a digital format, compresses the content and delivers the content to the encryption/decryption device 808 for encryption and subsequent delivery to the software application 806.

Similarly, device 822 receives and transmits data via a high-speed network connection 824. The actual speed of the network connection 824 will vary according to the device 822 and the content being received or transmitted. Network connection 824 can be a direct or network connection via a telephone line, a wireless network, a satellite network or any combination thereof. The network connection 824 is communicably coupled to a software application 826 that controls the encrypted content flow between the network connection 824 and the encryption/decryption device 828. The encryption/decryption device 828 is communicably coupled to a flash ROM key storage 830, a decoder/graphics controller 832 and an input/encoder 834. When the encryption/decryption device 828 receives encrypted content from the software application 826, it decrypts the content and sends the decrypted content to the decoder/graphics controller 830, which decompresses the decrypted content and performs a digital to analog conversion so that the decrypted and decompressed content can be displayed. Likewise, the input/encoder 834 receives analog or digital content, converts the content to a digital format, compresses the content and delivers the content to the encryption/decryption device 828 for encryption and subsequent delivery to the software application 826.

The encryption/decryption devices 808 and 826 can be implemented as a single chip or as all or part of a card. The flash ROM key storages 810 and 830 can be part of the encryption/decryption devices 808 and 826 respectively. The key storages 810 and 830 are used to store a unique private key that has been given to each device 802 and 822. At the time of purchase, the customer is given a certificate for the device 802 or 822 that contains the corresponding public key. When a video conference or other encrypted data transfer is desired, the devices exchange certificates and negotiate the proper encryption standard to be used. Thereafter, data transmission keys are created and exchanged so that content can be transmitted between the two devices 802 and 822.

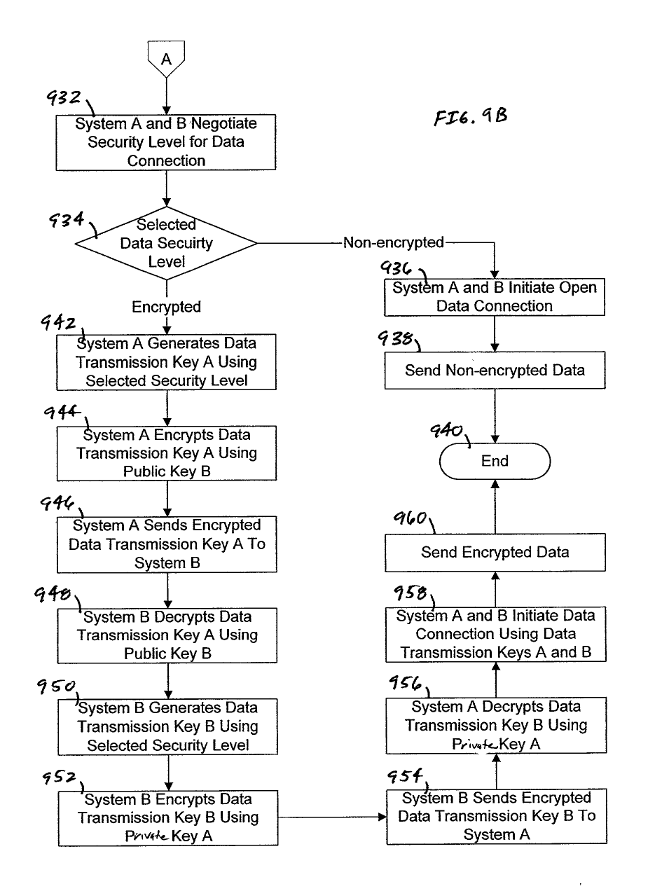

Referring now to FIGS. 9A and 9B, flowcharts of a peer-to-peer content delivery system in accordance with one embodiment of the present invention are shown. The process starts in block 902. System A initiates a communication link for control messages with System B in block 904. System A sends public key A to System B in block 906 and system B sends public key B to System A in block 908. In other words, System A and B exchange their public security keys. System A and B then negotiate the security level for the communication link for the control messages in block 910. The security level can be non-encrypted (“in the clear”) or a selected proprietary or standard encryption algorithm, such as a 3DES algorithm, an AES algorithm or a LFSR sequence. The selected security level will depend on the content being exchanged, the devices at either end, the communication link or the required data transfer rate.

If the selected security level for the control communication link is encrypted, as determined in decision block 912, System A generates a control transmission key A using the selected control security level encryption algorithm in block 914. System A then encrypts the control transmission key A using public key B in block 916 and sends the encrypted control transmission key A to System B in block 918 where System B decrypts the encrypted control transmission key A using private key B in block 920. Similarly, System B generates a control transmission key B using the selected control security level encryption algorithm in block 922. System B then encrypts the control transmission key B using public key A in block 924 and sends the encrypted control transmission key B to System A in block 926 where System A decrypts the encrypted control transmission key B using private key A in block 928. System A and B then initiate a new control communication link using control transmission keys A and B in block 930.

Once the new control communication link is initiated in block 930 or if the selected security level for the control communication link is unencrypted, as determined in decision block 912, System A and B then negotiate the security level for the communication link for the data or content in block 932. The security level can be non-encrypted (“in the clear”) or a selected proprietary or standard encryption algorithm, such as a 3DES algorithm, an AES algorithm or a LFSR sequence. The selected security level will depend on the content being exchanged, the devices at either end, the communication link or the required data transfer rate. If the selected security level for the data or content communication link is non-encrypted, as determined in decision block 934, System A and B then initiate an open data communication link in block 936 and exchange the non-encrypted data in block 938. Once the communications are complete, the process ends in block 940. Note that the present invention allows either system to request and subsequent change the selected security level for the control communication link during ongoing communications.

If the selected security level for the data communication link is encrypted, as determined in decision block 934, System A generates a data transmission key A using the selected data security level encryption algorithm in block 942. System A then encrypts the data transmission key A using public key B in block 944 and sends the encrypted data transmission key A to System B in block 946 where System B decrypts the encrypted data transmission key A using private key B in block 948. Similarly, System B generates a data transmission key B using the selected data security level encryption algorithm in block 950. System B then encrypts the data transmission key B using public key A in block 952 and sends the encrypted data transmission key B to System A in block 954 where System A decrypts the encrypted data transmission key B using private key A in block 956. System A and B then initiate a data communication link using data transmission keys A and B in block 958. System A and B then exchange the encrypted data in block 960. Once the communications are complete, the process ends in block 940. Note that the present invention allows either system to request and subsequent change the selected security level for the data communication link during ongoing communications.

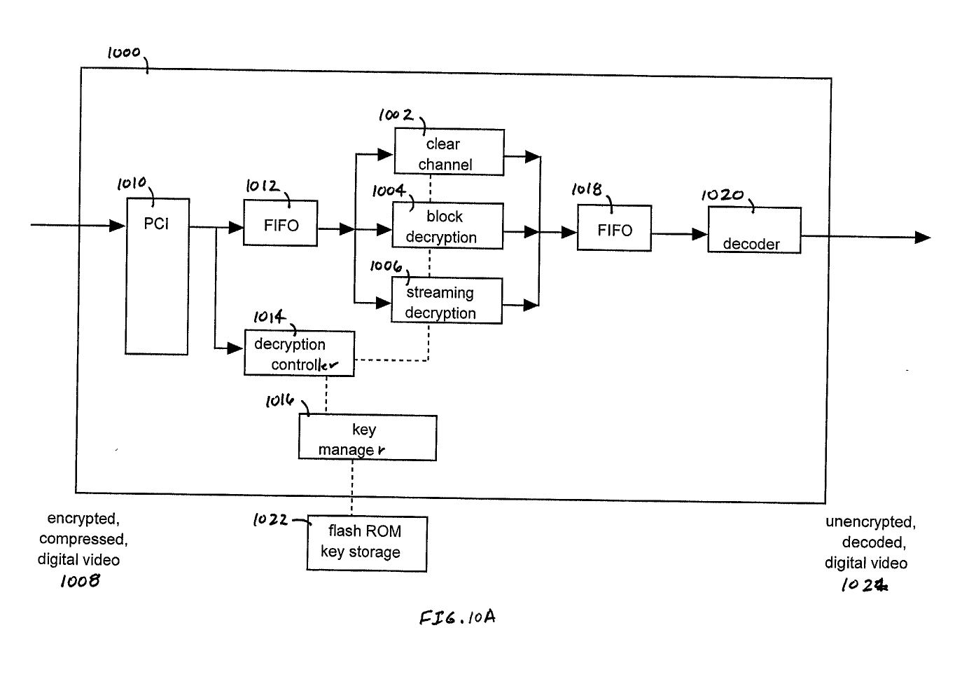

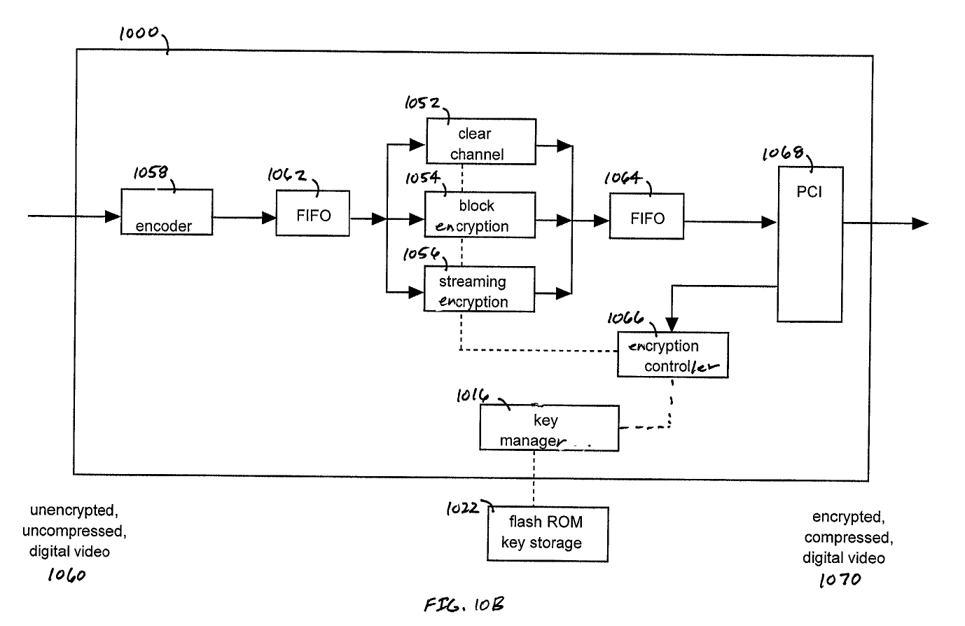

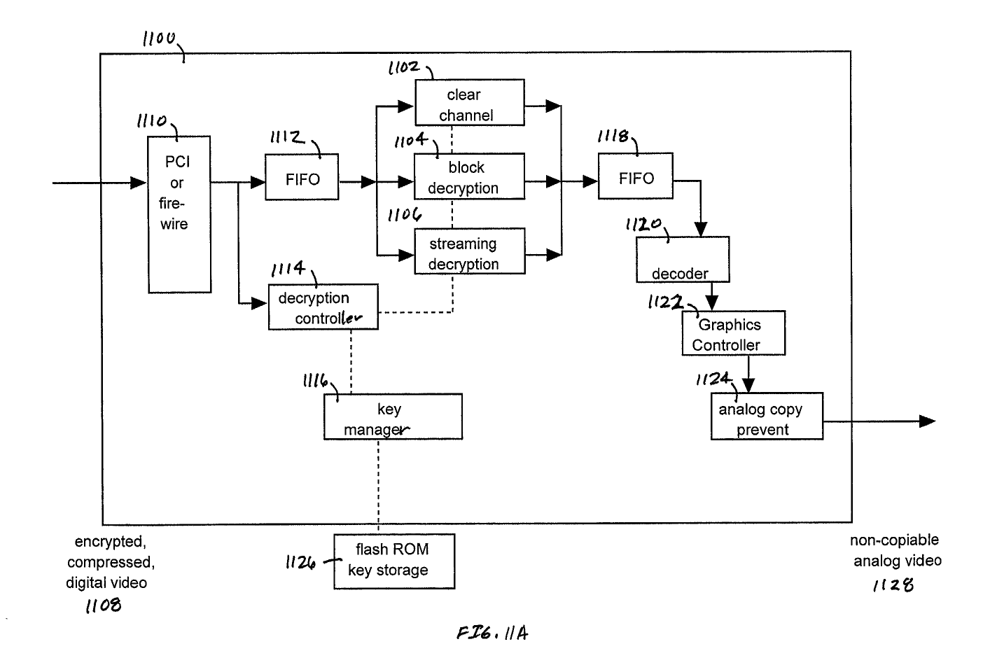

Now referring to FIG. 10A, a block diagram of a decryption path and decoding path of a peer device in accordance with one embodiment of the present invention is shown. The encryption/decryption device 1000 a multimode device because it can process unencrypted content (clear channel path 1002), content encrypted using a first decryption algorithm (block decryption path 1004) and a second decryption algorithm (streaming decryption path 1006). Note that a multimode encryption/decryption device 1000 is not required by the present invention. Also note that the present invention is not limited to a single algorithm for streaming encryption/decryption and a single algorithm for block encryption/decryption as both 3DES and AES algorithms could be implemented within a single embodiment of the present invention for block encryption/decryption. Nor is the present invention limited to a total of two encryption/decryption algorithms. For example, the present invention is capable of providing two or more types of block encryption/decryption and two or more types of streaming encryption/decryption within a single embodiment. The encryption/decryption device 1000 includes a PCI interface 1010 communicably coupled to a first buffer 1012 (first in, first out) and a decryption controller 1014. Note that the PCI interface 1010 can be any standard or high-speed digital interface, such as FireWire, USB-2, Fast Ethernet or AGP interfaces. The first buffer 1012 is communicably coupled to the clear channel path 1002, the block decryption path 1004 (first decryption algorithm) and the streaming decryption path 1006 (second decryption algorithm). The clear channel path 1002, the block decryption path 1004 (first decryption algorithm) and the streaming decryption path 1006 (second decryption algorithm) are communicably coupled to a second buffer 1018 (first in, first out), which is communicably coupled to an decoder 1020, such as an MPEG decoder. The decryption controller 1014 is communicably coupled to the clear channel path 1002, the block decryption path 1004 (first decryption algorithm), the streaming decryption path 1006 (second decryption algorithm) and a key manager 1016. The key manager 1016 is communicably coupled to the key storage 1022. The security keys are embedded within the hardware of the device 1000 so that they cannot be compromised by sharing data, such as electronic mail, newsgroup posts, file transfers, etc.

As shown, the encryption/decryption device 1000 receives encrypted, compressed digital content (audio/video) 1008 via the PCI interface 1010 and places the encrypted, compressed digital content (audio/video) 1008 in the first buffer 1012. The decryption controller 1014 checks the encrypted compressed digital content (audio/video) 1008 and determines which path 1002, 1004 or 1006 will process the content 1008. The decryption controller 1014 also monitors and controls the clear channel path 1002, the block decryption path 1004 (first decryption algorithm) and the streaming decryption path 1006 (second decryption algorithm). The clear channel path 1002 receives content from the first buffer 1012 and may perform some processing on the content before it is placed in the second buffer 1018. The decoder 1020 then receives the content from the second buffer 1018 and decompresses it for output as unencrypted, decoded digital content (audio/video) 1024.

The block decryption path 1004 (first decryption algorithm) receives content from the first buffer 1012 and decrypts the content using a first decryption algorithm before it is placed in the second buffer 1018 for processing by decoder 1020. The block decryption path 1004 (first decryption algorithm) uses a low to medium speed, high security, standard or proprietary encryption process, such as a 3DES algorithm or an AES algorithm. The block decryption path 1004 is typically used to decrypt content that is in a file format or other type of data block in a batch or off-line process. The decryption controller 1014 requests the appropriate security key from the key manager 1016 and provides the security key to the block decryption path 1004 for use in decrypting the content.

The streaming decryption path 1006 (second decryption algorithm) receives content from the first buffer 1012 and decrypts the content using a second decryption algorithm before it is placed in the second buffer 1018 for processing by decoder 1020. The streaming decryption path 1006 (second decryption algorithm) uses a high speed, medium security, standard or proprietary encryption process, such as a LFSR sequence. The streaming decryption path 1006 is typically used to decrypt content during a real time or near real time on line process. This provides low latency delays for interactive applications, such as gaming and video conferencing. This also reduces hardware complexity to allow the present invention to be easily integrated into portable client devices. The decryption controller 1014 requests the appropriate security key from the key manager 1016 and provides the security key to the streaming decryption path 1006 for use in decrypting the content.

Referring now to FIG. 10B, a block diagram of an encryption and encoding path of a peer device in accordance with one embodiment of the present invention is shown. As previously described, the encryption/decryption device 1000 is a multimode device because it can process unencrypted content (clear channel path 1052), content encrypted using a first encryption algorithm (block encryption path 1054) and a second encryption algorithm (streaming encryption path 1056). The encryption/decryption device 1000 includes an encoder 1058, such as a MPEG encoder, for compressing the unencrypted, uncompressed digital content (audio/video) 1060. The encoder 1058 is communicably coupled to the first buffer 1062 (first in, first out). The first buffer 1062 communicably coupled to the clear channel path 1052, the block encryption path 1054 (first encryption algorithm) and the streaming encryption path 1056 (second encryption algorithm). The clear channel path 1052, the block decryption path 1054 (first encryption algorithm) and the streaming decryption path 1056 (second encryption algorithm) are communicably coupled to a second buffer 1064 (first in, first out) and an encryption controller 1066. The second buffer 1064 is communicably coupled to a PCI interface 1068. The PCI interface 1068 is also communicably coupled to the encryption controller 1066. The encryption controller 1066 is communicably coupled to the clear channel path 1052, the block encryption path 1054 (first encryption algorithm), the streaming encryption path 1056 (second encryption algorithm) and the key manager 1016, which was previously described in reference to FIG. 10A.

As shown, the encryption/decryption device 1000 receives unencrypted, uncompressed digital content (audio/video) 1066 via encoder 1058, which compresses the content and sends the unencrypted, compressed, digital content (audio/video) to the first buffer 1062. The encryption controller 1066 determines which path 1052, 1054 or 1056 will process the content. The encryption controller 1066 also monitors and controls the clear channel path 1052, the block encryption path 1054 (first encryption algorithm) and the streaming encryption path 1056 (second encryption algorithm). Once processed and placed in the second buffer 1064, the encrypted, compressed digital content (audio/video) 1070 is sent out via the PCI interface 1068. Note that the PCI interface 1068 can be any standard or high-speed digital interface, such as FireWire, USB-2, Fast Ethernet or AGP interfaces. The clear channel path 1052 receives content from the first buffer 1062 and may perform some processing on the content before it is placed in the second buffer 1064.

The block encryption path 1054 (first encryption algorithm) receives content from the first buffer 1058 and encrypts the content using a first encryption algorithm before it is placed in the second buffer 1064. The block encryption path 1054 (first encryption algorithm) uses a low to medium speed, high security, standard or proprietary encryption process, such as a 3DES algorithm or an AES algorithm. The block encryption path 1054 is typically used to encrypt content that is in a file format or other type of data block in a batch or off-line process. The encryption controller 1066 requests the appropriate security key from the key manager 1016 and provides the security key to the block encryption path 1054 for use in encrypting the content.

The streaming encryption path 1056 (second encryption algorithm) receives content from the first buffer 1062 and encrypts the content using a second encryption algorithm before it is placed in the second buffer 1064. The streaming encryption path 1056 (second encryption algorithm) uses a high speed, medium security, standard or proprietary encryption process, such as a LFSR sequence. The streaming encryption path 1056 is typically used to encrypt content during a real time or near real time on line process. This provides low latency delays for interactive applications, such as gaming and video conferencing. This also reduces hardware complexity to allow the present invention to be easily integrated into portable client devices. The encryption controller 1066 requests the appropriate security key from the key manager 1016 and provides the security key to the streaming decryption path 1056 for use in decrypting the content.

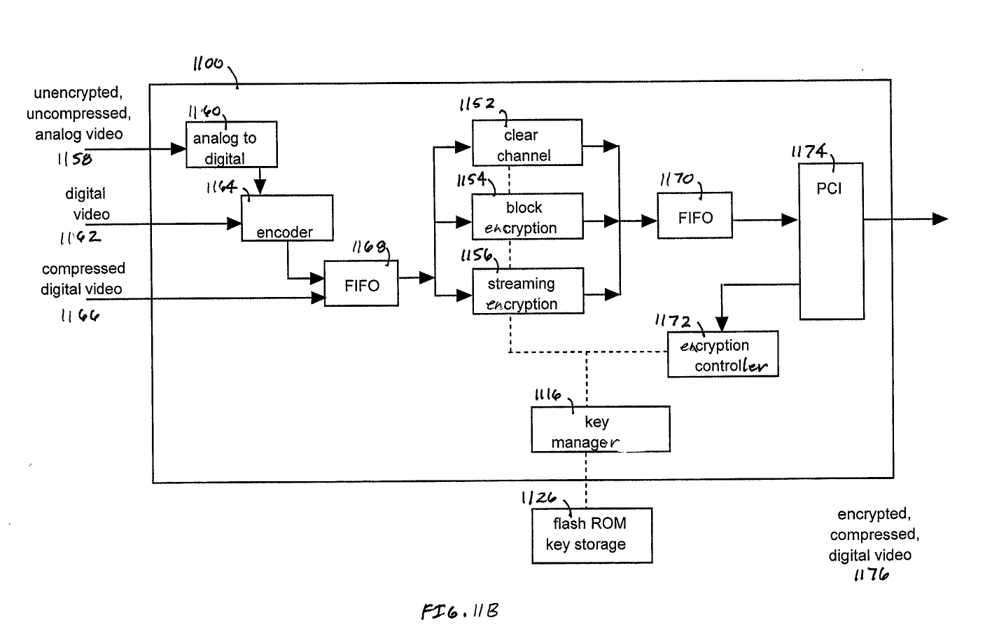

Now referring to FIG. 11A, a block diagram of a decryption path and decoding path of a peer device in accordance with another embodiment of the present invention is shown. The encryption/decryption device 1100 a multimode device because it can process unencrypted content (clear channel path 1102), content encrypted using a first decryption algorithm (block decryption path 1104) and a second decryption algorithm (streaming decryption path 1106). Note that a multimode encryption/decryption device 1100 is not required by the present invention. Also note that the present invention is not limited to a single algorithm for streaming encryption/decryption and a single algorithm for block encryption/decryption as both 3DES and AES algorithms could be implemented within a single embodiment of the present invention for block encryption/decryption. Nor is the present invention limited to a total of two encryption/decryption algorithms. For example, the present invention is capable of providing two or more types of block encryption/decryption and two or more types of streaming encryption/decryption within a single embodiment. The encryption/decryption device 1100 includes a PCI interface 1110 communicably coupled to a first buffer 1112 (first in, first out) and a decryption controller 1114. Note that the PCI interface 1110 can be any standard or high-speed digital interface, such as FireWire, USB-2, Fast Ethernet or AGP interfaces. The first buffer 1112 is communicably coupled to the clear channel path 1102, the block decryption path 1104 (first decryption algorithm) and the streaming decryption path 1106 (second decryption algorithm). The clear channel path 1102, the block decryption path 1104 (first decryption algorithm) and the streaming decryption path 1106 (second decryption algorithm) are communicably coupled to a second buffer 1118 (first in, first out), which is communicably coupled to an decoder 1120, such as an MPEG decoder. The decoder 1120 is communicably coupled to a graphics controller 1122, which is communicably coupled to an analog copy prevention device 1124. The decryption controller 1114 is communicably coupled to the clear channel path 1102, the block decryption path 1104 (first decryption algorithm), the streaming decryption path 1106 (second decryption algorithm) and a key manager 1116. The key manager 1116 is communicably coupled to the key storage 1126. The security keys are embedded within the hardware of the device 1100 so that they cannot be compromised by sharing data, such as electronic mail, newsgroup posts, file transfers, etc.

As shown, the encryption/decryption device 1100 receives encrypted, compressed digital content (audio/video) 1108 via the PCI interface 1110 and places the encrypted, compressed digital content (audio/video) 1108 in the first buffer 1112. The decryption controller 1114 checks the encrypted compressed digital content (audio/video) 1108 and determines which path 1102, 1104 or 1106 will process the content 1108. The decryption controller 1114 also monitors and controls the clear channel path 1102, the block decryption path 1104 (first decryption algorithm) and the streaming decryption path 1106 (second decryption algorithm). The clear channel path 1102 receives content from the first buffer 1112 and may perform some processing on the content before it is placed in the second buffer 1118. The decoder 1120 then receives the content from the second buffer 1118 and decompresses the content. The graphics controller 1122 then converts the content from a digital format to an analog format. Next, the analog copy prevention device 1124 modifies the content so that the output is cannot be copied by standard recording devices. As a result, the encryption/decryption device 1100 produces a non-copiable analog content (audio/video) 1128.

The block decryption path 1104 (first decryption algorithm) receives content from the first buffer 1112 and decrypts the content using a first decryption algorithm before it is placed in the second buffer 1118 for processing by decoder 1120. The block decryption path 1104 (first decryption algorithm) uses a low to medium speed, high security, standard or proprietary encryption process, such as a 3DES algorithm or an AES algorithm. The block decryption path 1104 is typically used to decrypt content that is in a file format or other type of data block in a batch or off-line process. The decryption controller 1114 requests the appropriate security key from the key manager 1116 and provides the security key to the block decryption path 1104 for use in decrypting the content.

The streaming decryption path 1106 (second decryption algorithm) receives content from the first buffer 1112 and decrypts the content using a second decryption algorithm before it is placed in the second buffer 1118 for processing by decoder 1120. The streaming decryption path 1106 (second decryption algorithm) uses a high speed, medium security, standard or proprietary encryption process, such as a LFSR sequence. The streaming decryption path 1106 is typically used to decrypt content during a real time or near real time on line process. This provides low latency delays for interactive applications, such as gaming and video conferencing. This also reduces hardware complexity to allow the present invention to be easily integrated into portable client devices. The decryption controller 1114 requests the appropriate security key from the key manager 1116 and provides the security key to the streaming decryption path 1106 for use in decrypting the content.

Referring now to FIG. 11B, a block diagram of an encryption path of a peer device in accordance with one embodiment of the present invention is shown. As previously described, the encryption/decryption device 1100 is a multimode device because it can process unencrypted content (clear channel path 1152), content encrypted using a first encryption algorithm (block encryption path 1154) and a second encryption algorithm (streaming encryption path 1156). The encryption/decryption device 1100 includes an analog to digital converter 1060 for receiving unencrypted, uncompressed, analog content (audio/video) 1058, an encoder 1158, such as a MPEG encoder, for receiving unencrypted, uncompressed, digital content (audio/video) 1062, and a first buffer 1068 (first in, first out) for receiving unencrypted, compressed, digital content (audio/video) 1066. The analog to digital converter 1060 is communicably coupled to the encoder 1064, which is communicably coupled to the first buffer 1068. The first buffer 1168 communicably coupled to the clear channel path 1152, the block encryption path 1154 (first encryption algorithm) and the streaming encryption path 1156 (second encryption algorithm). The clear channel path 1152, the block encryption path 1154 (first encryption algorithm) and the streaming encryption path 1156 (second encryption algorithm) are communicably coupled to a second buffer 1170 (first in, first out) and an encryption controller 1172. The second buffer 1170 is communicably coupled to a PCI interface 1174. The PCI interface 1174 is also communicably coupled to the encryption controller 1172. The encryption controller 1172 is communicably coupled to the clear channel path 1152, the block encryption path 1154 (first encryption algorithm), the streaming encryption path 1156 (second encryption algorithm) and the key manager 1116, which was previously described in reference to FIG. 11A.

As shown, the encryption/decryption device 1100 can receive unencrypted, uncompressed analog content (audio/video) 1158 via analog to digital converter 1160, which converts the content to an unencrypted, uncompressed digital content. The encryption/decryption device 1100 can also receive unencrypted, uncompressed digital content (audio/video) 1162 via analog to digital converter 1160 or encoder 1164, which converts the content to an unencrypted, compressed digital content. In addition, the encryption/decryption device 1100 can receive unencrypted, compressed digital content (audio/video) 1166 via encoder 1164 or first buffer 1168. The encryption controller 1172 determines which path 1152, 1154 or 1156 will process the content. The encryption controller 1172 also monitors and controls the clear channel path 1152, the block encryption path 1154 (first encryption algorithm) and the streaming encryption path 1156 (second encryption algorithm). Once processed and placed in the second buffer 1170, the encrypted, compressed digital content (audio/video) 1176 is sent out via the PCI interface 1174. The clear channel path 1152 receives content from the first buffer 1168 and may perform some processing on the content before it is placed in the second buffer 1170.

The block encryption path 1154 (first encryption algorithm) receives content from the first buffer 1168 and encrypts the content using a first encryption algorithm before it is placed in the second buffer 1170. The block encryption path 1154 (first encryption algorithm) uses a low to medium speed, high security, standard or proprietary encryption process, such as a 3DES algorithm or an AES algorithm. The block encryption path 1154 is typically used to encrypt content that is in a file format or other type of data block in a batch or off-line process. The encryption controller 1172 requests the appropriate security key from the key manager 1116 and provides the security key to the block encryption path 1154 for use in encrypting the content.

The streaming encryption path 1156 (second encryption algorithm) receives content from the first buffer 1168 and encrypts the content using a second encryption algorithm before it is placed in the second buffer 1170. The streaming encryption path 1156 (second encryption algorithm) uses a high speed, medium security, standard or proprietary encryption process, such as a LFSR sequence. The streaming encryption path 1156 is typically used to encrypt content during a real time or near real time on line process. This provides low latency delays for interactive applications, such as gaming and video conferencing. This also reduces hardware complexity to allow the present invention to be easily integrated into portable client devices. The encryption controller 1172 requests the appropriate security key from the key manager 1116 and provides the security key to the streaming decryption path 1156 for use in decrypting the content.

Those skilled in the art will appreciate that the embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method of providing encrypted data to a device comprising the steps of:
receiving one or more public keys from the device;
validating the one or more public keys;
receiving a request for the encrypted data from the device;
retrieving the encrypted data and a symmetric key used to encrypt the data;
encrypting the symmetric key using each of the one or more public keys; and
sending the one or more encrypted symmetric keys and the encrypted data to the device.

2. The method as recited in claim 1, further comprising the steps of:
receiving data;
creating the symmetric key; and
encrypting the data using the symmetric key.

3. The method as recited in claim 2, further comprising the step of storing the symmetric key and the encrypted data.

4. The method as recited in claim 2, wherein the data is compressed.

5. The method as recited in claim 4, wherein the data is compressed using a Moving Picture Experts Groups (“MPEG”) standard.

6. The method as recited in claim 2, further comprising the step of compressing the data.

7. The method as recited in claim 2, wherein the data is encrypted using a triple Data Encryption Standard (“3DES”) algorithm.

8. The method as recited in claim 2, wherein the data is encrypted using an Advanced Encryption Standard (“AES”) algorithm.

9. The method as recited in claim 1, wherein the data is encrypted using a symmetric linear feedback shift register (“LFSR”) sequence.

10. The method as recited in claim 1, further comprising the step of authorizing the request.

11. The method as recited in claim 1, wherein the encrypted data includes one or more terms of use.

12. The method as recited in claim 1, wherein the one or more terms of use comprises a view only once restriction.

13. The method as recited in claim 1, wherein the one or more terms of use comprises a limited time period to view the data.

14. The method as recited in claim 1, wherein the one or more terms of use comprises a reproduction restriction.

15. The method as recited in claim 1, wherein the steps of encrypting the symmetric key using each of the one or more public keys and sending the one or more encrypted symmetric keys and the encrypted data to the device comprise the steps of:
encrypting the symmetric key and one or more terms of use using each of one or more the public keys; and
sending the one or more encrypted symmetric keys, the one or more encrypted terms of use and the encrypted data to the device.

16. The method as recited in claim 1, wherein the step of sending the one or more encrypted symmetric keys and the encrypted data to the device comprises the steps of:
creating a file comprising the one or more encrypted symmetric keys and the encrypted data; and
sending the file to the device.

17. The method as recited in claim 1, further comprising the step of establishing a communication link with the device.

18. The method as recited in claim 1, wherein the communication link includes a telephone line.

19. The method as recited in claim 1, wherein the communication link includes a wireless connection.

20. The method as recited in claim 1, wherein the communication link includes a satellite connection.

21. The method as recited in claim 1, wherein the communication link includes the Internet.

22. The method as recited in claim 17, wherein the step of establishing a communication link with the device comprises the steps of:
establishing a control communication link with the device; and
establishing a data communication link with the device.

23. The method as recited in claim 1, wherein the data is an audio/video transmission.

24. The method as recited in claim 1, wherein the data is a sound recording.

25. The method as recited in claim 1, wherein the data is a game.

26. The method as recited in claim 1, wherein the device is an audio/video playback device.

27. The method as recited in claim 1, wherein the device is a computer.

28. The method as recited in claim 1, wherein the device is a personal data assistant.

29. The method as recited in claim 1, wherein the device is a wireless network device.

30. A computer program embodied on a computer readable medium of providing encrypted data to a device comprising:
a code segment for receiving one or more public keys from the device;
a code segment for validating the one or more public keys;
a code segment for receiving a request for the encrypted data from the device;
a code segment for retrieving the encrypted data and a symmetric key used to encrypt the data;
a code segment for encrypting the symmetric key using each of the one or more public keys; and
a code segment for sending the one or more encrypted symmetric keys and the encrypted data to the device.

31. The computer program as recited in claim 30, further comprising:
a code segment for receiving data;
a code segment for creating the symmetric key; and
a code segment for encrypting the data using the symmetric key.

32. The computer program as recited in claim 31, further comprising a code segment for storing the symmetric key and the encrypted data.

33. The computer program as recited in claim 31, wherein the data is compressed.

34. The computer program as recited in claim 33, wherein the data is compressed using a Moving Picture Experts Groups (“MPEG”) standard.

35. The computer program as recited in claim 31, further comprising a code segment for compressing the data.

36. The computer program as recited in claim 31, wherein the data is encrypted using a triple Data Encryption Standard (“3DES”) algorithm.

37. The computer program as recited in claim 31, wherein the data is encrypted using an Advanced Encryption Standard (“AES”) algorithm.

38. The computer program as recited in claim 30, wherein the data is encrypted using a symmetric linear feedback shift register (“LFSR”) sequence.

39. The computer program as recited in claim 30, further comprising a code segment for authorizing the request.

40. The computer program as recited in claim 30, wherein the encrypted data includes one or more terms of use.

41. The computer program as recited in claim 30, wherein the one or more terms of use comprises a view only once restriction.

42. The computer program as recited in claim 30, wherein the one or more terms of use comprises a limited time period to view the data.

43. The computer program as recited in claim 30, wherein the one or more terms of use comprises a reproduction restriction.

44. The computer program as recited in claim 30, wherein the code segments for encrypting the symmetric key using each of the one or more public keys and sending the one or more encrypted symmetric keys and the encrypted data to the device comprise:
a code segment for encrypting the symmetric key and one or more terms of use using each of one or more the public keys; and
a code segment for sending the one or more encrypted symmetric keys, the one or more encrypted terms of use and the encrypted data to the device.

45. The computer program as recited in claim 30, wherein the code segment for sending the one or more encrypted symmetric keys and the encrypted data to the device comprises:
a code segment for creating a file comprising the one or more encrypted symmetric keys and the encrypted data; and
a code segment for sending the file to the device.

46. The computer program as recited in claim 30, further comprising a code segment for establishing a communication link with the device.

47. The computer program as recited in claim 30, wherein the communication link includes a telephone line.

48. The computer program as recited in claim 30, wherein the communication link includes a wireless connection.

49. The computer program as recited in claim 30, wherein the communication link includes a satellite connection.

50. The computer program as recited in claim 30, wherein the communication link includes the Internet.

51. The computer program as recited in claim 46, wherein the code segment for establishing a communication link with the device comprises:
a code segment for establishing a control communication link with the device; and
a code segment for establishing a data communication link with the device.

52. The computer program as recited in claim 30, wherein the data is an audio/video transmission.

53. The computer program as recited in claim 30, wherein the data is a sound recording.

54. The computer program as recited in claim 30, wherein the data is a game.

55. The computer program as recited in claim 30, wherein the device is an audio/video playback device.

56. The computer program as recited in claim 30, wherein the device is a computer.

57. The computer program as recited in claim 30, wherein the device is a personal data assistant.

58. The computer program as recited in claim 30, wherein the device is a wireless network device.

59. A system for providing encrypted data to a device comprising:
a processor;
a data storage device communicably coupled to the processor;
a communications interface communicably coupled to the processor;
the processor receives one or more public keys from the device via the communications interface, validates the one or more public keys, receives a request for the encrypted data from the device via the communications interface, retrieves the encrypted data and a symmetric key used to encrypt the data from the data storage device, encrypts the symmetric key using each of the one or more public keys, and sends the one or more encrypted symmetric keys and the encrypted data to the device via the communications interface.

60. The system as recited in claim 59, wherein the processor receives data, creates the symmetric key and encrypts the data using the symmetric key.

61. The system as recited in claim 60, wherein the processor stores the symmetric key and the encrypted data in the data storage device.

62. The system as recited in claim 60, wherein the data is compressed.

63. The system as recited in claim 62, wherein the data is compressed using a Moving Picture Experts Groups (“MPEG”) standard.

64. The system as recited in claim 60, wherein the processor compresses the data.

65. The system as recited in claim 60, wherein the data is encrypted using a triple Data Encryption Standard (“3DES”) algorithm.

66. The system as recited in claim 60, wherein the data is encrypted using an Advanced Encryption Standard (“AES”) algorithm.

67. The system as recited in claim 59, wherein the data is encrypted using a symmetric linear feedback shift register (“LFSR”) sequence.

68. The system as recited in claim 59, wherein the processor authorizes the request.

69. The system as recited in claim 59, wherein the encrypted data includes one or more terms of use.

70. The system as recited in claim 59, wherein the one or more terms of use comprises a view only once restriction.

71. The system as recited in claim 59, wherein the one or more terms of use comprises a limited time period to view the data.

72. The system as recited in claim 59, wherein the one or more terms of use comprises a reproduction restriction.

73. The system as recited in claim 59, wherein the processor encrypts one or more terms of use using each of one or more the public keys and sends the one or more encrypted terms of use to the device via the communications interface.

74. The system as recited in claim 59, wherein the processor sends the one or more encrypted symmetric keys and the encrypted data to the device by creating a file comprising the one or more encrypted symmetric keys and the encrypted data, and sending the file to the device via the communications interface.

75. The system as recited in claim 59, the processor establishes a communication link between the communications interface and the device.

76. The system as recited in claim 59, wherein the communication link includes a telephone line.

77. The system as recited in claim 59, wherein the communication link includes a wireless connection.

78. The system as recited in claim 59, wherein the communication link includes a satellite connection.

79. The system as recited in claim 59, wherein the communication link includes the Internet.

80. The system as recited in claim 75, wherein processor establishes a communication link between the communications interface and the device by establishing a control communication link between the communications interface and the device and establishing a data communication link between the communications interface and the device.

81. The system as recited in claim 59, wherein the data is an audio/video transmission.

82. The system as recited in claim 59, wherein the data is a sound recording.

83. The system as recited in claim 59, wherein the data is a game.

84. The system as recited in claim 59, wherein the device is an audio/video playback device.

85. The system as recited in claim 59, wherein the device is a computer.

86. The system as recited in claim 59, wherein the device is a personal data assistant.

87. The system as recited in claim 59, wherein the device is a wireless network device.
